(19) United States
(12) Patent Application Publication
(10) Pub. No.: US 2015/0038632 A1
(43) Pub. Date: Feb. 5, 2015

(54) MOISTURE CURABLE ORGANOPOLYSILOXANE COMPOSITION

(71) Applicants: Sumi Dinkar, Bangalore (IN); Anantharaman Dhanabalan, Bangalore (IN)

(72) Inventors: Sumi Dinkar, Bangalore (IN); Anantharaman Dhanabalan, Bangalore (IN)

(21) Appl. No.: 14/516,602

(22) Filed: Oct. 17, 2014

Related U.S. Application Data
(63) Continuation of application No. PCT/US2013/029588, filed on Mar. 7, 2013.
(60) Provisional application No. 61/625,402, filed on Apr. 17, 2012.

(51) Int. Cl. C08L 83/04; C09J 183/04; C09D 183/04

(52) U.S. Cl. CPC C08L 83/04; C09D 183/04; C09J 183/04; C09J 2483/00; C08L 2205/025; C08L 2312/08
USPC 524/500

(57) ABSTRACT

The present invention provides curable compositions comprising non-tin metal catalysts that accelerate the condensation curing of moisture-curable silicones/non-silicones. In particular, the present composition employs a metal free catalyst system comprising a diazabicyclic compound as the catalyst. The diazabicyclic compounds exhibit catalytic activity comparable or superior to organotin such as DBTDL and exhibit certain behavior in the presence of components such as adhesion promoters that allow for tuning or adjusting the cure characteristics of the present compositions and provide good adhesion and storage stability.

### CROSS REFERENCE TO RELATED APPLICATIONS

This application is a continuation of International Patent Application No.: PCT/US2013/029588, entitled “Moisture Curable Organopolysiloxane Composition,” filed on Mar. 7, 2013, which claims the priority benefit of U.S. Provisional Patent Application No. 61/625,402, entitled “Moisture Curable Organopolysiloxane Composition,” filed on Apr. 17, 2012, each of which are hereby incorporated in their entirety by reference.

### FIELD

The present invention relates to curable compositions comprising curable polymers having reactive terminal silyl groups and tin-free, metal-free catalysts. In particular, the present invention provides curable compositions comprising diazabicyclic compounds as alternatives to organotin catalysts.

### BACKGROUND

Polymers having reactive terminal silyl groups or compositions comprising such polymers can be hydrolyzed and condensed in the presence of water and metal catalysts. Suitable known catalysts for curable compositions include compounds employing compounds of metals such as Sn, Ti, Zn, or Ca. Organotin compounds such as, for example, dibutyltin dilaurate (DBTDL) are widely used as condensation cure catalysts to accelerate the moisture-assisted curing of a number of different polyorganosiloxanes and non-silicone polymers having reactive terminal silyl groups such as room temperature vulcanizing (RTV) formulations including RTV-1 and RTV-2 formulations. Environmental regulatory agencies and directives, however, have increased or are expected to increase restrictions on the use of organotin compounds in formulated products. For example, while formulations with greater than 0.5 wt. % dibutyltin presently require labeling as toxic with reproductive 1B classification, dibutyltin-containing formulations are proposed to be completely phased out in consumer applications during the next four to six years.

The use of alternative organotin compounds such as dioctyltin compounds and dimethyltin compounds can only be considered as a short-term remedial plan, as these organotin compounds may also be regulated in the future. It would be beneficial to identify non-tin metal catalysts that accelerate the condensation curing of moisture-curable silicones and non-silicones. Desirably, substitutes for organotin catalysts should exhibit properties similar to organotin compounds in terms of curing, storage, and appearance. Non-tin catalysts would also desirably initiate the condensation reaction of the selected polymers and complete this reaction upon the surface and may be in the bulk in a desired time schedule. There are therefore many proposals for the replacement of organometallic tin compounds with other metal-based compounds. These compounds comprise metals such as Ca, Ce, Bi, Fe, Mo, Mn, Pb, Ti, V, Zn, and Y. These other metals have specific advantages and disadvantages in view of replacing tin compounds perfectly. Therefore, there is still a need to address the limitations of possible metal compounds as suitable catalysts for condensation cure reactions. The physical properties of uncured and cured compositions also warrant examination, in particular to maintain the ability to adhere onto the surface of several substrates.

### SUMMARY

The present invention provides tin-free, curable compositions comprising silyl-terminated polymers and a non-toxic condensation catalyst based on diazabicyclic compounds. In one aspect, the present invention provides a metal-free curable composition. Applicants have found that diazabicyclic compounds function as a curing catalyst in the absence of other catalytic materials and in the absence of fluorosilane compounds. Additionally, the diazabicyclic catalyst materials work with a wide range of adhesion promoters and generally do not exhibit the poisoning effects that adhesion promoters may have on curable composition employing metal-based catalyst complexes.

In one embodiment, the present invention provides a composition for forming a cured polymer composition comprising (A) a polymer having at least a reactive silyl group; (B) a crosslinker or chain extender; (C) a catalyst comprising a diazabicyclic compound; (D) an optional adhesion promoter; (E) an optional filler component and (F) an optional acidic compound. In one embodiment, the diazabicyclic compound comprises an amidine linkage. In one embodiment, the diazabicyclic compound is present in an amount of from about 0.01 to about 7 parts per weight per 100 parts per weight of the polymer (A).

In one embodiment, the polymer (A) has the formula: [R¹ₐR²₃₋ₐSi—Z—]ₙ—X—Z—SiR¹ₐR²₃₋ₐ. In another embodiment, X is chosen from a polyurethane; a polyester; a polyether; a polycarbonate; a polyolefin; a polyester ether; and a polyorganosiloxane having units of R₃SiO_{1/2}, R₂SiO, RSiO_{3/2}, and/or SiO₂, n is 0 to 100, a is 0 to 2, R and R¹ can be identical or different at the same silicon atom and chosen from C₁-C₁₀ alkyl; C₁-C₁₀ alkyl substituted with one or more of Cl, F, N, O, or S; a phenyl; C₇-C₁₆ alkylaryl; C₇-C₁₆ arylalkyl; C₂-C₂₀-polyalkylene ether; or a combination of two or more thereof. In yet another aspect, R² is chosen from OH, alkoxy, alkoxyalkyl, alkoxyaryl, oximoalkyl, oximoaryl, enoxyalkyl, enoxyaryl, aminoalkyl, aminoaryl, carboxyalkyl, carboxyaryl, amidoalkyl, amidoaryl, carbamatoalkyl, carbamatoaryl, or a combination of two or more thereof, and Z is a bond, a divalent unit selected from the group of a C₁-C₁₄ alkylene, or O.

According to one embodiment, the crosslinker component (B) is chosen from tetraethylorthosilicate (TEOS), a polycondensate of TEOS, methyltrimethoxysilane (MTMS), vinyltrimethoxysilane, methylvinyldimethoxysilane, dimethyldimethoxysilane, dimethyldiethoxysilane, vinyltriethoxysilane, tetra-n-propylorthosilicate, tris(methylethylketoximo)vinylsilane, tris(methylethylketoximo)methylsilane, tris(acetamido)methylsilane, bis(acetamido)dimethylsilane, tris(N-methylacetamido)methylsilane, bis(N-methylacetamido)dimethylsilane, (N-methylacetamido)methyldialkoxysilane, tris(benzamido)methylsilane, tris(propenoxy)methylsilane, alkyldialkoxyamidosilanes, alkylalkoxybisamidosilanes, methylethoxybis(N-methylbenzamido)silane, methylethoxydibenzamidosilane, methyldimethoxy(ethylmethylketoximo)silane; bis(ethylmethylketoximo)methylmethoxysilane; (acetaldoximo)methyldimethoxysilane; (N-methylcarbamato)methyldimethoxysilane; (N-methylcarbamato)ethyldimethoxy silane; (isopropenoxy)methyldimethoxysilane; (isopropenoxy)trimethoxysilane; tris(isopropenoxy)methylsilane; (but-2-en-2-oxy)methyldimethoxysilane; (1-phenylethenoxy)methyldimethoxysilane; 2-((1-carboethoxy)propenoxy)methyldimethoxysilane; bis(N-methylamino)methylmethoxysilane; (N-methylamino)vinyldimethoxysilane; tetrakis(N,N-diethylamino)silane; methyldimethoxy(N-methylamino)silane; methyltris(cyclohexylamino)silane; methyldimethoxy(N-ethylamino)silane; dimethylbis(N,N-dimethylamino)silane; methyldimethoxy(N-isopropylamino)silane dimethylbis(N,N-diethylamino)silane; ethyldimethoxy(N-ethylpropionamido)silane; methyldimethoxy(N-methylacetamido)silane; methyltris(N-methylacetamido)silane; ethyldimethoxy(N-methylacetamido)silane; methyltris(N-methylbenzamido)silane; methylmethoxybis(N-methylacetamido)silane; methyldimethoxy(ε-caprolactamo)silane; trimethoxy(N-methylacetamido)silane; methyldimethoxy(O-ethylacetimidato)silane; methyldimethoxy(O-propylacetimidato)silane; methyldimethoxy(N,N′,N′-trimethylureido)silane; methyldimethoxy(N-allyl-N′,N′-dimethylureido)silane; methyldimethoxy(N-phenyl-N′,N′-dimethylureido)silane; methyldimethoxy(isocyanato)silane; dimethoxydiisocyanatosilane; methyldimethoxyisothiocyanatosilane; methylmethoxydiisothiocyanatosilane; methyltriacetoxysilane; methylmethoxydiacetoxysilane; methylethoxydiacetoxysilane; methylisopropoxydiacetoxysilane; methyl(n-propoxy)diacetoxysilane; methyldimethoxyacetoxysilane; methyldiethoxyacetoxysilane; methyldiisopropoxyacetoxysilane; methyldi(n-propoxy)acetoxysilane; or a combination of two or more thereof.

According to one embodiment, the adhesion promoter component (D) is chosen from an (aminoalkyl)trialkoxysilane, an (aminoalkyl)alkyldialkoxysilane, a bis(trialkoxysilylalkyl)amine, a tris(trialkoxysilylalkyl)amine, a tris(trialkoxysilylalkyl)cyanuarate, a tris(trialkoxysilylalkyl)isocyanurate, an (epoxyalkyl)trialkoxysilane, an (epoxyalkylether)trialkoxysilane, or a combination of two or more thereof.

According to one embodiment, the component (F) is chosen from a phosphate ester of the formula: (R³O)PO(OH)₂; a phosphite ester of the formula (R³O)P(OH)₂; or a phosphonic acid of the formula: R³P(O)(OH)₂. In another aspect, R³ is a C₁-C₁₈ alkyl, a C₂-C₂₀ alkoxyalkyl, phenyl, a C₇-C₁₂ alkylaryl, a C₂-C₄ polyalkylene oxide ester or its mixtures with diesters; a branched C₄-C₁₄ alkyl carboxylic acid; or a combination of two or more thereof.

According to one embodiment, the composition comprises about 1 to about 10 wt. % of the crosslinker component (B) based on 100 wt. % of the polymer component (A).

According to one embodiment, the crosslinker component (B) is chosen from a silane or a siloxane, the silane or siloxane having two or more reactive groups that can undergo hydrolysis and/or condensation reaction with polymer (A) or on its own in the presence of water and component (F).

According to one embodiment, the polymer component (A) is chosen from a polyorganosiloxane comprising divalent units of the formula [R₂SiO] in the backbone, wherein R is chosen from C₁-C₁₀ alkyl; C₁-C₁₀ alkyl substituted with one or more of Cl, F, N, O, or S; phenyl; C₇-C₁₆ alkylaryl; C₇-C₁₆ arylalkyl; C₂-C₂₀ polyalkylene ether; or a combination of two or more thereof.

According to one embodiment, the catalyst (C) is present in an amount of from about 0.01 to about 7 wt. pt. per 100 wt. pt. of component (A).

According to one embodiment, the component (F) is present in an amount of from about 0.02 to about 7 wt. pt. per 100 wt. pt. of component (A).

According to one embodiment, the polymer component (A) has the formula: R²₃₋ₐR¹ₐSi—Z—[R₂SiO]ₓ—[R¹₂SiO]_{y}—Z—SiR¹ₐR²₃₋ₐ whereby x is 0 to 10000; y is 0 to 1000; a is 0 to 2; R is methyl. In another aspect, R¹ is chosen from a C₁-C₁₀ alkyl; a C₁-C₁₀ alkyl substituted with one or more of Cl, F, N, O, or S; a phenyl; a C₇-C₁₆ alkylaryl; a C₇-C₁₆ arylalkyl; a C₂-C₂₀ polyalkylene ether; or a combination of two or more thereof, and other siloxane units may be present in amounts less than 10 mol. % preferably methyl, vinyl, phenyl. In yet another embodiment, R² is chosen from OH, a C₁-C₈ alkoxy, a C₂-C₁₈ alkoxyalkyl, an oximoalkyl, an enoxyalkyl, an aminoalkyl, a carboxyalkyl, an amidoalkyl, an amidoaryl, a carbamatoalkyl, or a combination of two or more thereof, and Z is —O—, a bond, or —C₂H₄—.

According to one embodiment, the composition further comprises a solvent chosen from an alkylbenzene, a trialkylphosphate, a triarylphosphate, a phthalic acid ester, an arylsulfonic acid ester having a viscosity-density constant (VDC) of at least 0.86 that is miscible with a polyorganosiloxane and catalyst component (C), a polyorganosiloxane devoid of reactive groups and having a viscosity of less than 2000 mPa·s at 25° C., or a combination of two or more thereof.

According to one embodiment, the composition is provided as a one-part composition.

According to one embodiment, the composition comprises 100 pt. wt. of component (A); 0.1 to about 10 pt. wt. of at least one crosslinker (B); 0.01 to about 7 pt. wt. of a catalyst (C); 0.1 to about 5 pt. wt. of an adhesion promoter (D); 0 to about 300 pt. wt. of filler component (E); 0 to about 8 pt. wt. of component (F) whereby this composition can be stored in the absence of humidity and is curable in the presence of humidity upon exposure to ambient air.

According to one embodiment, the composition is a two-part composition comprising: (i) a first portion comprising the polymer component (A), optionally the filler component (E), and optionally the acidic compound (F); and (ii) a second portion comprising the crosslinker (B), the catalyst component (C), the adhesion promoter (D), and optionally the acidic compound (F), whereby (i) and (ii) are stored separately until applied for curing by mixing of the components (i) and (ii).

According to one embodiment, portion (i) comprises 100 wt. % of component (A), and 0 to 70 pt. wt. of component (E); and portion (ii) comprises 0.1 to 10 pt. wt. of at least one crosslinker (B), 0.01 to 7 pt. wt. of a catalyst (C), 0 to 5 pt. wt. of an adhesion promoter (D), and 0 to 3 pt. wt. component (F).

In another aspect, the present invention provides a method of providing a cured material comprising exposing the composition to ambient air.

According to one embodiment, a method of providing a cured material comprises combining the first portion and the second portion and curing the mixture.

According to one embodiment, the composition is stored in a sealed cartridge or flexible bag having outlet nozzles for extrusion and/or shaping of the uncured composition prior to cure.

In still another aspect, the present invention provides a cured polymer material formed from the composition.

According to one embodiment, the cured polymer material is in the form of an elastomeric or duromeric seal, an adhesive, a coating, an encapsulant, a shaped article, a mold, or an impression material.

The compositions are found to exhibit good storage stability and adhere to a variety of surfaces. In one embodiment, the curable compositions exhibit excellent adherence to thermoplastic surfaces, including polyacrylate and polymethylmethacrylate (PMMA) surfaces.

### DETAILED DESCRIPTION

The present invention provides a curable composition employing a tin-free, metal-free catalyst as a condensation catalyst. The metal-free catalysts comprise a diazabicyclic compound and exhibit similar or superior curing properties as compared to compositions employing organotin compounds, such as DBTDL, in terms of accelerating moisture-assisted condensation curing of silicones to result in cross-linked silicones that can be used as sealants and RTVs (Room-Temperature Vulcanized Rubber). The non-toxic nature of these compounds makes them more attractive and practical than organotin catalysts, given the forthcoming strict regulations on organotin catalysts.

In one embodiment, the present invention provides a curable composition comprising a polymer component (A) comprising a reactive terminal silyl group; a crosslinker component (B); a catalyst component (C) comprising an diazabicyclic compound; optionally an adhesion promoter component (D); an optional filler component (E); optionally an acidic compound (F), and optionally auxiliary components (G).

The polymer component (A) may be a liquid- or solid-based polymer having a reactive terminal silyl group. The polymer component (A) is not particularly limited and may be chosen from any silyl cross-linkable polymer as may be desired for a particular purpose or intended use. Non-limiting examples of suitable polymers for the polymer component (A) include polyorganosiloxanes (A1) or organic polymers free of siloxane bonds (A2), wherein the polymers (A1) and (A2) comprise reactive terminal silyl groups. In one embodiment, the polymer component (A) may be present in an amount of from about 10 to about 90 wt. % of the curable composition. In one embodiment, the curable composition comprises about 100 pt. wt. of the polymer component (A).

As described above, the polymer component (A) may include a wide range of polyorganosiloxanes. In one embodiment, the polymer component may comprise one or more polysiloxanes and copolymers of formula (2):

[R¹_{c}R²_{3-c}Si—Z—]ₙ—X—Z—SiR¹_{c}R²_{3-c} (2)

R¹ may be chosen from linear or branched alkyl, linear or branched heteroalkyl, cycloalkyl, heterocycloalkyl, aryl, heteroaryl, linear or branched aralkyl, linear or branched heteroaralkyl, or a combination of two or more thereof. In one embodiment, R¹ may be chosen from C₁-C₁₀ alkyl; C₁-C₁₀ alkyl substituted with one or more of Cl, F, N, O, or S; phenyl; C₇-C₁₆ alkylaryl; C₇-C₁₆ arylalkyl; C₂-C₂₀ polyalkylene ether; or a combination of two or more thereof. Exemplary preferred groups are methyl, trifluoropropyl, and/or phenyl groups.

R² may be a group reactive to protic agents such as water. Exemplary groups for R² include OH, alkoxy, alkoxyalkyl, alkenyloxy, alkyloximo, alkylcarboxy, arylcarboxy, alkylamido, arylamido, or a combination of two or more thereof. In one embodiment, R² is chosen from OH, C₁-C₈ alkoxy, C₂-C₁₈ alkoxyalkyl, amino, alkenyloxy, alkyloximo, alkylamino, arylamino, alkylcarboxy, arylcarboxy, alkylamido, arylamido, alkylcarbamato, arylcarbamato, or a combination of two or more thereof.

Z may be a bond, a divalent linking unit selected from the group of O, hydrocarbons which can contain one or more O, S, or N atom, amide, urethane, ether, ester, urea units or a combination of two or more thereof. If the linking group Z is a hydrocarbon group, then Z is linked to the silicon atom over a silicon-carbon bond. In one embodiment, Z is chosen from a C₁-C₁₄ alkylene.

X is chosen from a polyurethane; a polyester; a polyether; a polycarbonate; a polyolefin; a polyester ether; and a polyorganosiloxane having units of R¹₃SiO_{1/2}, R¹₂SiO, R¹SiO_{3/2}, and/or SiO₂, where R¹ is defined as above. X may be a divalent or multivalent polymer unit selected from the group of siloxy units linked over oxygen or hydrocarbon groups to the terminal silyl group comprising the reactive group R² as described above, polyether, polyalkylene, polyisoalkylene, polyester, or polyurethane units linked over hydrocarbon groups to the silicon atom comprising one or more reactive groups R² as described above. The hydrocarbon group X can contain one or more heteroatoms such as N, S, O, or P forming amides, esters, ethers, urethanes, esters, and/or ureas. In one embodiment, the average polymerization degree (Pₙ) of X should be more than 6, e.g. polyorganosiloxane units of R¹₃SiO_{1/2}, R¹₂SiO, R¹SiO_{3/2}, and/or SiO₂. In formula (2), n is 0 to 100; desirably 1, and c is 0 to 2, desirably 0 to 1.

Non-limiting examples of the components for unit X include polyoxyalkylene polymers such as polyoxyethylene, polyoxypropylene, polyoxybutylene, polyoxyethylene-polyoxypropylene copolymer, polyoxytetramethylene, or polyoxypropylene-polyoxybutylene copolymer; ethylene-propylene copolymer, polyisobutylene, polychloroprene, polyisoprene, polybutadiene, copolymer of isobutylene and isoprene, copolymers of isoprene or butadiene and acrylonitrile and/or styrene, or hydrocarbon polymers such as hydrogenated polyolefin polymers produced by hydrogenating these polyolefin polymers; polyester polymer manufactured by a condensation of dibasic acid such as adipic acid or phthalic acid and glycol, or ring-opening polymerization of lactones; polyacrylic acid ester produced by radical polymerization of a monomer such as C₂-C₈-alkyl acrylates, vinyl polymers, e.g., acrylic acid ester copolymer of acrylic acid ester such as ethyl acrylate or butyl acrylate and vinyl acetate, acrylonitrile, methyl methacrylate, acrylamide, or styrene; graft polymer produced by polymerizing the above organic polymer with a vinyl monomer; polycarbonates; polysulfide polymer; polyamide polymer such as Nylon 6 produced by ring-opening polymerization of 8-caprolactam, Nylon 6-6 produced by polycondensation of hexamethylenediamine and adipic acid, etc., Nylon 12 produced by ring-opening polymerization of 8-laurolactam, copolymeric polyamides, polyurethanes, or polyureas.

Particularly suitable polymers include, but are not limited to, polysiloxanes, polyoxyalkylenes, saturated hydrocarbon polymers such as polyisobutylene, hydrogenated polybutadiene and hydrogenated polyisoprene, or polyethylene, polypropylene, polyesters, polycarbonates, polyurethanes, polyurea polymers and the like. Furthermore, saturated hydrocarbon polymer, polyoxyalkylene polymer, and vinyl copolymer are particularly suitable due to their low glass transition temperature which provide a high flexibility at low temperatures, i.e., below 0° C.

The reactive silyl groups in formula (2) can be introduced by employing silanes containing a functional group which has the ability to react by known methods with unsaturated hydrocarbons via hydrosilylation, or reaction of SiOH, aminoalkyl or -aryl, HOOC-alkyl or -aryl, HO-alkyl or -aryl, HS-alkyl or -aryl, Cl(O)C-alkyl or -aryl, epoxyalkyl or epoxycycloalkyl groups in the prepolymer to be linked to a reactive silyl group via condensation or ring-opening reactions. Examples of the main embodiments include the following: (i) siloxane prepolymers having a SiOH group that can undergo a condensation reaction with a silane (LG)SiR¹_{c}R²_{3-c}, whereby a siloxy bond ≡Si—O—SiR¹_{c}R²_{3-c}, is formed while the addition product of the leaving group (LG) and hydrogen is released (LG-H); (ii) silanes having an unsaturated group that is capable of reacting via hydrosilylation or radical reaction with a SiH group or radically activated groups of a silane such as SiH or an unsaturated group; and (iii) silanes including organic or inorganic prepolymers having OH, SH, amino, epoxy, —COCl, —COOH groups, which can react complementarily with epoxy, isocyanato, OH, SH, cyanato, carboxylic halogenides, reactive alkylhalogenides, lactones, lactams, or amines, that is to link the reactive prepolymer with the organofunctional silanes to yield a silyl functional polymer.

Silanes suitable for method (i) include alkoxysilanes, especially tetraalkoxysilanes, di- and trialkoxysilanes, di- and triacetoxysilanes, di- and triketoximosilanes, di- and trialkenyloxysilanes, di- and tricarbonamidosilanes, wherein the remaining residues at the silicon atom of the silane are substituted or unsubstituted hydrocarbons. Other non-limiting silanes for method (i) include alkyltrialkoxysilanes, such as vinyltrimethoxysilane, methyltrimethoxysilane, propyltrimethoxysilane, amino alkyltrimethoxysilane, ethyltriacetoxysilane, methyl- or propyltriacetoxysilane, methyltributanonoximosilane, methyltripropenyloxysilane, methyltribenzamidosilane, or methyltriacetamidosilane. Prepolymers suitable for reaction under method (i) are SiOH-terminated polyalkylsiloxanes, which can undergo a condensation reaction with a silane having hydrolyzable groups attached to the silicon atom. Exemplary SiOH-terminated polyalkyldisiloxanes include polydimethylsiloxanes.

Suitable silanes for method (ii) include alkoxysilanes, especially trialkoxysilanes (HSi(OR)₃) such as trimethoxysilane, triethoxysilane, methyldiethoxysilane, methyldimethoxysilane, and phenyldimethoxysilane. Hydrogenchlorosilanes are in principle possible but are less desirable due to the additional replacement of the halogen through an alkoxy, acetoxy group, etc. Other suitable silanes include organofunctional silanes having unsaturated groups which can be activated by radicals, such as vinyl, allyl, mercaptoalkyl, or acrylic groups. Non-limiting examples include vinyltrimethoxysilane, mercaptopropyltrimethoxysilane, and methacryloxypropyltrimethoxysilane. Prepolymers suitable for reaction under method (ii) include vinyl-terminated polyalkylsiloxanes, preferably polydimethylsiloxanes, hydrocarbons with unsaturated groups which can undergo hydrosilylation or can undergo radically induced grafting reactions with a corresponding organofunctional group of a silane comprising, for example, unsaturated hydrocarbon or a SiH group.

Another method for introducing silyl groups into hydrocarbon polymers can be the copolymerization of unsaturated hydrocarbon monomers with the unsaturated groups of silanes. The introduction of unsaturated groups into a hydrocarbon prepolymer may include, for example, the use of alkenyl halogenides as chain stopper after polymerization of the silicon free hydrocarbon moiety.

Desirable reaction products between the silanes and prepolymers include the following structures:

—SiR¹₂O—SiR¹₂—CH₂—CH₂—SiR¹_{c}R²_{3-c}, or (hydrocarbon)-[Z—SiR¹_{c}R²_{3-c}]ₙ

Suitable silanes for method (iii) include, but are not limited to, alkoxy silanes, especially silanes having organofunctional groups to be reactive to —OH, —SH, amino, epoxy, —COCl, or —COOH.

In one embodiment, these silanes have an isocyanatoalkyl group such as gamma-isocyanatopropyltrimethoxysilane, gamma-isocyanatopropylmethyldimethoxysilane, gamma-isocyanatopropyltriethoxysilane, gamma-glycidoxypropylethyldimethoxysilane, gamma-glycidoxypropyltrimethoxysilane, gamma-glycidoxypropyltriethoxysilane, beta-(3,4-epoxycyclohexyl)ethyltrimethoxysilane, beta-(3,4-epoxycyclohexyl)ethyltriethoxysilane, epoxylimonyltrimethoxysilane, N-(2-aminoethyl)-aminopropyltrimethoxysilane, gamma-aminopropyltriethoxysilane, gamma-aminopropyltrimethoxysilane, gamma-aminopropylmethyldimethoxysilane, gamma-aminopropylmethyldiethoxysilane, etc.

In one embodiment, it is desirable to select either blocked amines or isocyanates (Z′—X)ₙ—Z′ for carrying out first a complete mixing and then the following coupling reaction. Examples of blocking agents are disclosed in EP 0947531 and other blocking procedures that employ heterocyclic nitrogen compounds such as caprolactam or butanone oxime, or cyclic ketones referred to in U.S. Pat. No. 6,827,875 both of which are incorporated herein by reference in their entirety.

Examples of suitable prepolymers for a reaction under method (iii) include, but are not limited to, polyalkylene oxides having OH groups, preferably with a high molecular weight (M_{w}, weight-average molecular weight >6000 g/mol) and a polydispersity M_{w}/Mₙ of less than 1.6; urethanes having remaining NCO groups, such as NCO functionalized polyalkylene oxides, especially blocked isocyanates. Prepolymers selected from the group of hydrocarbons having —OH, —COOH, amino, epoxy groups, which can react complementarily with an epoxy, isocyanato, amino, carboxyhalogenide or halogenalkyl group of the corresponding silane having further reactive groups useful for the final cure.

Suitable isocyanates for the introduction of a NCO group into a polyether may include toluene diisocyanate, diphenylmethane diisocyanate, or xylene diisocyanate, or aliphatic polyisocyanate such as isophorone diisocyanate, or hexamethylene diisocyanate.

The polymerization degree of the unit X depends on the requirements of viscosity and mechanical properties of the cured product. If X is a polydimethylsiloxane unit, the average polymerization degree based on the number average molecular weight Mₙ is preferably 7 to 5000 siloxy units, preferably 200 to 2000 units. In order to achieve a sufficient tensile strength of >5 MPa, an average polymerization degree Pₙ of >250 is suitable whereby the polydimethylsiloxanes have a viscosity of more than 300 mPa·s at 25° C. If X is a hydrocarbon unit other than a polysiloxane unit, the viscosity with respect to the polymerization degree is much higher.

Examples of the method for synthesizing a polyoxyalkylene polymer include, but are not limited to, a polymerization method using an alkali catalyst such as KOH, a polymerization method using a metal-porphyrin complex catalyst such as a complex obtained by reacting an organoaluminum compound, a polymerization method using a composite metal cyanide complex catalyst disclosed, e.g., in U.S. Pat. Nos. 3,427,256; 3,427,334; 3,278,457; 3,278,458; 3,278,459; 3,427,335; 6,696,383; and 6,919,293.

If the group X is selected from hydrocarbon polymers, then polymers or copolymers having isobutylene units are particularly desirable due to its physical properties such as excellent weatherability, excellent heat resistance, and low gas and moisture permeability.

Examples of the monomers include olefins having 4 to 12 carbon atoms, vinyl ether, aromatic vinyl compound, vinylsilanes, and allylsilanes. Examples of the copolymer component include 1-butene, 2-butene, 2-methyl-1-butene, 3-methyl-1-butene, pentene, 4-methyl-1-pentene, hexene, vinylcyclohexene, methyl vinyl ether, ethyl vinyl ether, isobutyl vinyl ether, styrene, alpha-methylstyrene, dimethylstyrene, beta-pinene, indene, and for example, but not limited to, vinyltrialkoxysilanes, e.g. vinyltrimethoxysilane, vinylmethyldichlorosilane, vinyldimethylmethoxysilane, divinyldichlorosilane, divinyldimethoxysilane, allyltrichlorosilane, allylmethyldichlorosilane, allyldimethylmethoxysilane, diallyldichlorosilane, diallyldimethoxysilane, gamma-methacryloyloxypropyltrimethoxysilane, and gamma-methacryloyloxypropylmethyldimethoxysilane.

Examples of suitable siloxane-free organic polymers include, but are not limited to, silylated polyurethane (SPUR), silylated polyester, silylated polyether, silylated polycarbonate, silylated polyolefins like polyethylene, polypropylene, silylated polyesterether and combinations of two or more thereof. The siloxane-free organic polymer may be present in an amount of from about 10 to about 90 wt. % of the composition or about 100 pt. wt.

In one embodiment, the polymer component (A) may be a silylated polyurethane (SPUR). Such moisture curable compounds are known in the art in general and can be obtained by various methods including (i) reacting an isocyanate-terminated polyurethane (PUR) prepolymer with a suitable silane, e.g., one possessing both hydrolyzable functionality at the silicon atom, such as, alkoxy, etc., and secondly active hydrogen-containing functionality such as mercaptan, primary or secondary amine, preferably the latter, etc., or by (ii) reacting a hydroxyl-terminated PUR (polyurethane) prepolymer with a suitable isocyanate-terminated silane, e.g., one possessing one to three alkoxy groups. The details of these reactions, and those for preparing the isocyanate-terminated and hydroxyl-terminated PUR prepolymers employed therein can be found in, amongst others: U.S. Pat. Nos. 4,985,491; 5,919,888; 6,207,794; 6,303,731; 6,359,101; and 6,515,164, and published U.S. Patent Publication Nos. 2004/0122253 and US 2005/0020706 (isocyanate-terminated PUR prepolymers); U.S. Pat. Nos. 3,786,081 and 4,481,367 (hydroxyl-terminated PUR prepolymers); U.S. Pat. Nos. 3,627,722; 3,632,557; 3,971,751; 5,623,044; 5,852,137; 6,197,912; and 6,310,170 (moisture-curable SPUR (silane modified/terminated polyurethane) obtained from reaction of isocyanate-terminated PUR prepolymer and reactive silane, e.g., aminoalkoxysilane); and, U.S. Pat. Nos. 4,345,053; 4,625,012; 6,833,423; and published U.S. Patent Publication 2002/0198352 (moisture-curable SPUR obtained from reaction of hydroxyl-terminated PUR prepolymer and isocyanatosilane). The entire contents of the foregoing U.S. patent documents are incorporated by reference herein. Other examples of moisture-curable SPUR materials include those described in U.S. Pat. No. 7,569,653, the disclosure of which is incorporated by reference in its entirety.

In one embodiment, the polymer component (A) may be a polymer of formula (3):

R²_{3-c}R¹_{c}Si—Z—[R₂SiO]ₓ[R¹₂SiO]_{y}—Z—SiR¹_{c}R²_{3-c} (3)

where R¹, R², Z, and c are defined as above with respect to formula (3); R is C₁-C₆ alkyl (an exemplary alkyl being methyl); x is 0 to about 10,000, in one embodiment from 11 to about 2500; and y is 0 to about 10,000; preferably 0 to 500. In one embodiment, Z in a compound of formula (3) is a bond or a divalent C₁-C₁₄ alkylene group, especially preferred is —C₂H₄—.

In one embodiment, the polymer component (A) may be a polyorganosiloxane of the formula (4):

R²_{3-c-d}SiR³_{c}R⁴_{d}—[OSiR³R⁴]ₓ—[OSiR³R⁴]_{y}—OSiR³ₑR⁴_{f}R²_{3-e-f} (4)

R³ and R⁴ can be identical or different on the same silicon atom and are chosen from hydrogen; C₁-C₁₀ alkyl; C₁-C₁₀ heteroalkyl, C₃-C₁₂ cycloalkyl; C₂-C₃₀ heterocycloalkyl; C₆-C₁₃ aryl; C₇-C₃₀ alkylaryl; C₇-C₃₀ arylalkyl; C₄-C₁₂ heteroaryl; C₅-C₃₀ heteroarylalkyl; C₅-C₃₀ heteroalkylaryl; C₂-C₁₀₀ polyalkylene ether; or a combination of two or more thereof. R², c, x, and y are as defined above; d is 0, 1, or 2; e is 0, 1, or 2; and f is 0, 1, or 2.

Non-limiting examples of suitable polysiloxane-containing polymers (A1) include, for example, silanol-stopped polydimethylsiloxane, silanol or alkoxy-stopped polyorganosiloxanes, e.g., methoxystopped polydimethylsiloxane, alkoxy-stopped polydimethylsiloxane-polydiphenylsiloxane copolymer, and silanol or alkoxy-stopped fluoroalkyl-substituted siloxanes such as poly(methyl 3,3,3-trifluoropropyl)siloxane and poly(methyl 3,3,3-trifluoropropyl)siloxane-polydimethyl siloxane copolymer. The polyorganosiloxane component (A1) may be present in an amount of about 10 to about 90 wt. % of the composition or 100 pt. wt. In one preferred embodiment, the polyorganosiloxane component has an average chain length in the range of about 10 to about 2500 siloxy units, and the viscosity is in the range of about 10 to about 500,000 mPa·s at 25° C.

Alternatively, the composition may include silyl-terminated organic polymers (A2) that are free of siloxane units, and which undergo curing by a condensation reaction comparable to that of siloxane containing polymers (A1). Similar to the polyorganosiloxane polymer (A1), the organic polymers (A2) that are suitable as the polymer component (A) include a terminal silyl group. In one embodiment, the terminal silyl group may be of the formula (5):

—SiR¹_{d}R²_{3-d} (5)

where R¹, R², and d are as defined above.

The polysiloxane composition may further include a crosslinker or a chain extender as component (B). In one embodiment, the crosslinker is of the formula (6):

R¹_{d}SiR²_{4-d} (6)

wherein R¹, R², and d are as defined above. Alternatively, the crosslinker component may be a condensation product of formula (6) wherein one or more but not all R² groups are hydrolyzed and released in the presence of water and then intermediate silanols undergo a condensation reaction to give a Si—O—Si bond and water. The average polymerization degree can result in a compound having 2 to 10 Si units.
In one embodiment, the crosslinker is an alkoxysilane having a formula R³_{d}(R¹O)_{4-d}Si, wherein R¹, R³, and d are defined as above. In another embodiment, the crosslinker is an acetoxysilane having a formula (R³_{d}(R¹CO₂)_{4-d}Si, wherein R¹, R³, and d are defined as above. In still another embodiment, the crosslinker is an oximosilane having a formula R³_{d}(R¹R⁴C═N—O)_{4-d}Si, where R¹, R³, R⁴, and d are defined as above.

As used herein, the term crosslinker includes a compound including an additional reactive component having at least two hydrolysable groups and less than three silicon atoms per molecule not defined under (A). In one embodiment, the crosslinker or chain extender may be chosen from an alkoxysilane, an alkoxysiloxane, an oximosilane, an oximosiloxane, an enoxysilane, an enoxysiloxane, an aminosilane, an aminosiloxane, a carboxysilane, a carboxysiloxane, an alkylamidosilane, an alkylamidosiloxane, an arylamidosilane, an arylamidosiloxane, an alkoxyaminosilane, an alkylarylaminosiloxane, an alkoxycarbamatosilane, an alkoxycarbamatosiloxane, an imidatosilane, a ureidosilane, an isocyanatosilane, a isothiocyanatosilane, and combinations of two or more thereof. Examples of suitable cross-linkers include, but are not limited to, tetraethylorthosilicate (TEOS); methyltrimethoxysilane (MTMS); methyltriethoxysilane; vinyltrimethoxysilane; vinyltriethoxysilane; methylphenyldimethoxysilane; 3,3,3-trifluoropropyltrimethoxysilane; methyltriacetoxysilane; vinyltriacetoxysilane; ethyltriacetoxysilane; di-butoxydiacetoxysilane; phenyltripropionoxysilane; methyltris(methylethylketoximo)silane; vinyltris(methylethylketoximo)silane; 3,3,3-trifluoropropyltris(methylethylketoximo)silane; methyltris(isopropenoxy)silane; vinyltris(isopropenoxy)silane; ethylpolysilicate; dimethyltetraacetoxydisiloxane; tetra-n-propylorthosilicate; methyldimethoxy(ethylmethylketoximo)silane; methylmethoxybis(ethylmethylketoximo)silane; methyldimethoxy(acetaldoximo)silane; methyldimethoxy(N-methylcarbamato)silane; ethyldimethoxy(N-methylcarbamato)silane; methyldimethoxyisopropenoxysilane; trimethoxyisopropenoxysilane; methyltriisopropenoxysilane; methyldimethoxy(but-2-en-2-oxy)silane; methyldimethoxy(1-phenylethenoxy) silane; methyldimethoxy-2-(1-carboethoxypropenoxy)silane; methylmethoxydi(N-methylamino)silane; vinyldimethoxy(methylamino)silane; tetra-N,N-diethylaminosilane; methyldimethoxy(methylamino)silane; methyltri(cyclohexylamino)silane; methyldimethoxy(ethylamino)silane; dimethyldi(N,N-dimethylamino)silane; methyldimethoxy(isopropylamino)silane; dimethyldi(N,N-diethylamino)silane; ethyldimethoxy(N-ethylpropionamido)silane; methyldimethoxy(N-methylacetamido)silane; methyltris(N-methylacetamido)silane; ethyldimethoxy(N-methylacetamido)silane; methyltris(N-methylbenzamido)silane; methylmethoxybis(N-methylacetamido)silane; methyldimethoxy(caprolactamo)silane; trimethoxy(N-methylacetamido)silane; methyldimethoxy(ethylacetimidato)silane; methyldimethoxy(propylacetimidato)silane; methyldimethoxy(N,N′,N′-trimethylureido)silane; methyldimethoxy(N-allyl-N′,N′-dimethylureido)silane; methyldimethoxy(N-phenyl-N′,N′-dimethylureido)silane; methyldimethoxyisocyanatosilane; dimethoxydiisocyanatosilane; methyldimethoxyisothiocyanatosilane; methylmethoxydiisothiocyanatosilane, or combinations of two or more thereof. In one embodiment, the crosslinker may be present in an amount from about 1 to about 10 wt. % of the composition or from about 0.1 to about 10 pt. wt. per 100 pt. wt. of the polymer component (A). In another embodiment, the crosslinker may be present in an amount from about 0.1 to about 5 pt. wt. per 100 pt. wt. of the polymer component (A). In still another embodiment, the crosslinker may be present in an amount from about 0.5 to about 3 pt. wt. per 100 pt. wt. of the polymer component (A). Here as elsewhere in the specification and claims, numerical values may be combined to form new or undisclosed ranges.

Additional alkoxysilanes in an amount greater than 0.1 wt. % of component (A) that are not consumed by the reaction between the prepolymer Z′—X—Z′ and which comprise additional functional groups selected from R⁵ can also work as an adhesion promoter and are defined and counted under component (D).

The curable compositions further comprise a metal-free catalyst (C) chosen from a diazabicyclic compound. The inventors have unexpectedly found that diazabicyclic compounds exhibit excellent catalytic activity by themselves and are found to work satisfactorily in most of the compositions, e.g., typical sealant RTV-1 or RTV-2 formulations, comprising polymers having reactive terminal groups, which may additionally contain other ingredients. Similar to DBTDL, the diazabicyclic compounds are liquid in nature, which allows for easy handling of materials and does not require the aid of dispersing solvent. Additionally, the diazabicyclic compounds are colorless. This allows for the production of clear materials and also allows for fine tuning the color of the curable composition to provide a color of interest by the addition of selected pigments. Even in fine tuning or providing colored compositions, the colorless liquid provides an advantage over catalysts that exhibit some color in that color selection can be accomplished without having to determine the complimentary color or concentration necessary to achieve a desired color.

The diazabicyclic compounds utilized as the cure catalysts can be chosen from a variety of diazabicylcic compounds and are not particularly limited. The two rings in the bicyclic compound can be provided by separate ring structures joined by a chemical bond or linking group, at least one of which ring structures comprises a diaza functional group; a fused ring; or a bridged structure. The nitrogen atoms can be placed anywhere within the rings. In one embodiment, each ring in the structure contains a nitrogen atom. In one embodiment of a fused ring or bridged structure, each ring shares at least one nitrogen atom. In one embodiment, the nitrogen atoms can be bonded to the same carbon atom. In one embodiment, the diazabicyclic compound comprises an amidine (N—C═N) linkage.

In one embodiment, the diazabicyclic comprises a first cyclic group comprising a diaza functionality and a second cyclic group attached to the first cyclic group through a chemical bond or a linking group. The second cyclic group can be attached to the first cyclic group through a bond or other linkage that is bonded to a nitrogen atom on the first cyclic group. Examples of suitable cyclic groups comprising diaza functionality include, but are not limited to, diaziridine, diazetidine, imidazolidine, perazine, diazepane, diazocane, etc. The location of the nitrogen atoms is not critical, and rings comprising the diaza functionality can have the nitrogen atoms in the 1,2; 1,3; 1,4; 1,5, etc. positions. In one embodiment, the nitrogen atoms in the diaza functionality are in the 1,2 positions.

The second cyclic group can be chose from any suitable cyclic group as desired for a particular purpose or intended use. In one embodiment, the second cyclic group can be chosen from a cycloaliphatic group, an aryl, a heterocycle, a heteroaryl, etc. In one embodiment the second cyclic group can a C₃-C₁₀ cycloaliphatic group, a C₆-C₁₀ aryl group, a 3-10 membered heterocycle, or a 6-10 membered heteroaryl, etc.

The term “cycloaliphatic” (or “carbocycle” or “carbocyclyl” or “carbocyclic”) refers to a non-aromatic carbon only containing ring system that can be saturated or contains one or more units of unsaturation, having three to fourteen ring carbon atoms. In some embodiments, the number of carbon atoms is 3 to 10. In other embodiments, the number of carbon atoms is 4 to 7. In yet other embodiments, the number of carbon atoms is 5 or 6. The term includes monocyclic, bicyclic or polycyclic, fused, spiro or bridged carbocyclic ring systems. The term also includes polycyclic ring systems in which the carbocyclic ring can be “fused” to one or more non-aromatic carbocyclic or heterocyclic rings or one or more aromatic rings or combination thereof, wherein the radical or point of attachment is on the carbocyclic ring. “Fused” bicyclic ring systems comprise two rings which share two adjoining ring atoms. Bridged bicyclic group comprise two rings which share three or four adjacent ring atoms. Spiro bicyclic ring systems share one ring atom. Examples of cycloaliphatic groups include, but are not limited to, cycloalkyl and cycloalkenyl groups. Specific examples include, but are not limited to, cyclooctyl, cyclohexyl, cyclopropenyl, and cyclobutyl.

The term “heterocycle” (or “heterocyclyl,” or “heterocyclic” or “non-aromatic heterocycle”) as used herein refers to a non-aromatic ring system that can be saturated or contain one or more units of unsaturation, having three to fourteen ring atoms in which one or more ring carbons is replaced by a heteroatom such as, N, S, or O and each ring in the system contains 3 to 7 members. In some embodiments, non-aromatic heterocyclic rings comprise up to three heteroatoms selected from N, S and O within the ring. In other embodiments, non-aromatic heterocyclic rings comprise up to two heteroatoms selected from N, S and O within the ring system. In yet other embodiments, non-aromatic heterocyclic rings comprise up to two heteroatoms selected from N and O within the ring system. The term includes monocyclic, bicyclic or polycyclic fused, spiro or bridged heterocyclic ring systems. The term also includes polycyclic ring systems in which the heterocyclic ring can be fused to one or more non-aromatic carbocyclic or heterocyclic rings or one or more aromatic rings or combination thereof, wherein the radical or point of attachment is on the heterocyclic ring. Examples of heterocycles include, but are not limited to, piperidinyl, piperizinyl, pyrrolidinyl, pyrazolidinyl, imidazolidinyl, azepanyl, diazepanyl, triazepanyl, azocanyl, diazocanyl, triazocanyl, oxazolidinyl, isoxazolidinyl, thiazolidinyl, isothiazolidinyl, oxazocanyl, oxazepanyl, thiazepanyl, thiazocanyl, benzimidazolonyl, tetrahydrofuranyl, tetrahydrofuranyl, tetrahydrothiophenyl, tetrahydrothiophenyl, morpholino, including, for example, 3-morpholino, 4-morpholino, 2-thiomorpholino, 3-thiomorpholino, 4-thiomorpholino, 1-pyrrolidinyl, 2-pyrrolidinyl, 3-pyrrolidinyl, 1-tetrahydropiperazinyl, 2-tetrahydropiperazinyl, 3-tetrahydropiperazinyl, 1-piperidinyl, 2-piperidinyl, 3-piperidinyl, 1-pyrazolinyl, 3-pyrazolinyl, 4-pyrazolinyl, 5-pyrazolinyl, 1-piperidinyl, 2-piperidinyl, 3-piperidinyl, 4-piperidinyl, 2-thiazolidinyl, 3-thiazolidinyl, 4-thiazolidinyl, 1-imidazolidinyl, 2-imidazolidinyl, 4-imidazolidinyl, 5-imidazolidinyl, indolinyl, tetrahydroquinolinyl, tetrahydroisoquinolinyl, benzothiolanyl, benzodithianyl, 3-(1-alkyl)-benzimidazol-2-onyl, and 1,3-dihydro-imidazol-2-onyl.

The term “aryl” (or “aryl ring” or “aryl group”) used alone or as part of a larger moiety as in “aralkyl,” “aralkoxy,” “aryloxyalkyl,” or “heteroaryl” refers to carbocyclic aromatic ring systems. The term “aryl” may be used interchangeably with the terms “aryl ring” or “aryl group”. “Carbocyclic aromatic ring” groups have only carbon ring atoms (typically six to fourteen) and include monocyclic aromatic rings such as phenyl and fused polycyclic aromatic ring systems in which two or more carbocyclic aromatic rings are fused to one another. Examples include 1-naphthyl, 2-naphthyl, 1-anthracyl and 2-anthracyl. Also included within the scope of the term “carbocyclic aromatic ring” or “carbocyclic aromatic,” as it is used herein, is a group in which an aromatic ring is “fused” to one or more non-aromatic rings (carbocyclic or heterocyclic), such as in an indanyl, phthalimidyl, naphthimidyl, phenanthridinyl, or tetrahydronaphthyl, where the radical or point of attachment is on the aromatic ring.

The terms “heteroaryl,” “heteroaromatic,” “heteroaryl ring,” “heteroaryl group,” “aromatic heterocycle” or “heteroaromatic group,” used alone or as part of a larger moiety as in “heteroaralkyl” or “heteroarylalkoxy,” refer to heteroaromatic ring groups having five to fourteen members, in which one or more ring carbons is replaced by a heteroatom such as, N, S, or O. In some embodiments, heteroaryl rings comprise up to three heteroatoms selected from N, S and O within the ring. In other embodiments, heteroaryl rings comprise up to two heteroatoms selected from N, S and O within the ring system. In yet other embodiments, heteroaryl rings comprise up to two heteroatoms selected from N and O within the ring system. Heteroaryl rings include monocyclic heteroaromatic rings and polycyclic aromatic rings in which a monocyclic aromatic ring is fused to one or more other aromatic rings. Also included within the scope of the term “heteroaryl,” as it is used herein, is a group in which an aromatic ring is “fused” to one or more non-aromatic rings (carbocyclic or heterocyclic), where the radical or point of attachment is on the aromatic ring. Bicyclic 6,5 heteroaromatic ring, as used herein, for example, is a six membered heteroaromatic ring fused to a second five membered ring, wherein the radical or point of attachment is on the six membered ring. Examples of heteroaryl groups include pyridyl, pyrazinyl, pyrimidinyl, pyridazinyl, imidazolyl, pyrrolyl, pyrazolyl, triazolyl, tetrazolyl, oxazolyl, isoxazolyl, oxadiazolyl, thiazolyl, isothiazolyl or thiadiazolyl including, for example, 2-furanyl, 3-furanyl, N-imidazolyl, 2-imidazolyl, 4-imidazolyl, 5-imidazolyl, 3-isoxazolyl, 4-isoxazolyl, 5-isoxazolyl, 2-oxadiazolyl, 5-oxadiazolyl, 2-oxazolyl, 4-oxazolyl, 5-oxazolyl, 3-pyrazolyl, 4-pyrazolyl, 1-pyrrolyl, 2-pyrrolyl, 3-pyrrolyl, 2-pyridyl, 3-pyridyl, 4-pyridyl, 2-pyrimidinyl, 4-pyrimidinyl, 5-pyrimidinyl, 3-pyridazinyl, 2-thiazolyl, 4-thiazolyl, 5-thiazolyl, 2-triazolyl, 5-triazolyl, tetrazolyl, 2-thienyl, 3-thienyl, carbazolyl, benzimidazolyl, benzothienyl, benzofuranyl, indolyl, benzotriazolyl, benzothiazolyl, benzoxazolyl, benzimidazolyl, isoquinolinyl, indolyl, isoindolyl, acridinyl, benzisoxazolyl, isothiazolyl, 1,2,3-oxadiazolyl, 1,2,5-oxadiazolyl, 1,2,4-oxadiazolyl, 1,2,3-triazolyl, 1,2,3-thiadiazolyl, 1,3,4-thiadiazolyl, 1,2,5-thiadiazolyl, purinyl, pyrazinyl, 1,3,5-triazinyl, quinolinyl (e.g., 2-quinolinyl, 3-quinolinyl, 4-quinolinyl), and isoquinolinyl (e.g., 1-isoquinolinyl, 3-isoquinolinyl, or 4-isoquinolinyl).

In one embodiment, the diazabicyclic compound is chosen from a compound of the formula (7):

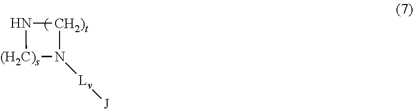

where s is an integer from 1 to 8, t is 0 or an integer from 1 to 4; J is a cyclic compound; L is a linking group, and v is 0-10. In one embodiment, J can be chosen from a cycloaliphatic group, an aryl, a heterocycle, a heteroaryl, etc. In one embodiment, v is 0.

Examples of suitable linking groups L include, but are not limited to, —O—, —COO—, —S—, —CONH—, —HN—CO—NH—, alkyl, alkene, aryl, epoxy, aryl group containing a heteroatomic group chosen from —O—, —COO—, —S—, —CONH—, —HN—CO—NH—, epoxy, etc.

In one embodiment, the bicyclic compound is of the formula:

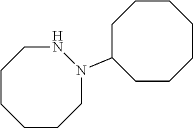 [SMILES: C1CCCC(N2CCCCCCN2)CCC1]

In one embodiment, the diazabicyclic compound is chosen from a compound of the formula (8):

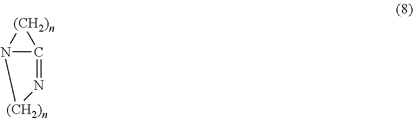

where n is an integer from 1-10.

In one embodiment, the diazabicyclic compound is chosen from a compound of the formula (9):

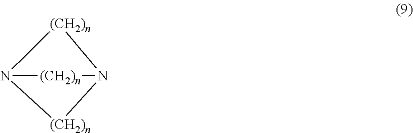

where n is an integer from 1-10.

In one embodiment, the diazabicyclic compound is chosen from a compound of the formula (10):

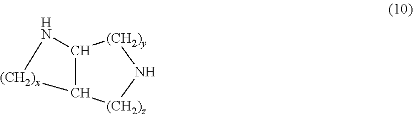

where x is an integer from 1-10, y is an integer from 0-10, and z is an integer from 0-10, where at least one of y and/or z is at least 1.

The catalyst component (C) can comprise a single diazabicyclic compound or a mixture of two or more diazabicyclic compounds. Examples of suitable diazabicylic compounds for the catalyst include, but are not limited to, 1,5-diazabicyclo[4.2.0]oct-5-ene; 1,5-diazabicyclo[4.3.0]non-5-ene; 1,5-diaza-3,methylbicyclo[4.3.0]non-5-ene; 1,5-diazabicyclo[4.4.0]dec-5-ene; 1,5-diaza-10-methylbicyclo[4.4.0]dec-5-ene; 1,8-diazabicycl[5.4.0]undec-7-ene (hereinafter referred to as DBU); 1,9-diazabicyclo[6.4.0]dodec-8-ene; 1,10-diazabicyclo[7.4.0]tridec-9-ene; 1,14-diazabicyclo[11.4.0]heptadec-13-ene; 6-dibutylamino-1,8-diazabicyclo[5,4,0]undec-7-ene; 1,4-diazabicyclo[2,2,2]octane; 2,6-diazabicyclo[3.2.0]heptane; 3,6-diazabicyclo[3.2.0]heptane; 2,7-diazabicyclo[4.2.0]octane; 3,7-diazabicyclo[4.2.0]octane; 2,8-diazabicyclo[4.2.0]octane; 2,6-diazabicyclo[3.3.0]octane; 2,7-diazabicyclo[3.3.0]octane; 2,7-diazabicyclo[4.3.0]octane; 2,8-diazabicyclo[4.3.0]nonane; 3,7-diazabicyclo[4.3.0]nonane; 3,8-diazabicyclo[4.3.0]nonane; 3,9-diazabicyclo[4.3.0]nonane; 2,6-diazabicyclo[3.2.1]octane; 3,6-diazabicyclo[3.2.1]octane, etc.,

In one embodiment, the catalyst component (C) can comprise a salt of a diazabicyclic compound. In its salt form, the diazabicyclic compound can comprise a mixture of the diazabicyclic compound any suitable counter ion. In one embodiment, the salt form comprises a mixture of a diazabicyclic compound and a sulfonic acid.

The catalyst component (C) comprising the diazabicyclic compound can be present in the curable composition in an amount of from about 0.01 to about 7 parts per weight per 100 parts per weight of the polymer (A); from about 0.05 to about 5 parts per weight per 100 parts per weight of the polymer (A); from about 0.1 to about 2 parts per weigh per 100 parts per weight of the polymer (A); even from about 0.2 to about 1 parts per weight per 100 parts per weight of the polymer (A). Here as elsewhere in the specification and claims, numerical values may be combined to form new and non-disclosed ranges. Applicants have found that the curing rate, at least as measured by tack-free time (TFT), can be increased or decreased by increasing or decreasing the loading of the diazabicyclic compounds.

The composition optionally includes an adhesion promoter component (D) that is different from component (A) or (B). In one embodiment, the adhesion promoter (D) may be an organofunctional silane comprising the group R⁵, e.g., aminosilanes, and other silanes that are not identical to the silanes of component (B), or are present in an amount that exceeds the amount of silanes necessary for end capping the polymer (A). The amount of non-reacted silane (B) or (D) in the reaction for making (A) can be defined in that after the endcapping reaction the free silanes are evaporated at a higher temperature up to 200° C. and vacuum up to 1 mbar to be more than 0.1 wt. % of (A).

While the diazabicyclic catalyst compounds can exhibit cure properties at least as good as tin catalysts, the adhesion promoters can be added to promote adhesion of the resulting cured material to a variety of substrates. It has been found that the diazabicyclic catalyst materials can be utilized with a variety of adhesion promoters without loss in catalytic activity as has been found with some metal-based, non-tin catalysts. The combination of the adhesion promoter with the diazabicyclic catalyst can provide a composition exhibiting improved curing characteristics compared to the diazabicyclic compound alone. Thus, some selected amines can advantageously be added to fine tune the rate of the diazabicyclic catalyzed condensation curing of silicone/non-silicone polymer containing reactive silyl groups, as desired.

In one embodiment, the composition comprises an adhesion promoter (D) comprising a group R⁵ as described by the general formula (11):

R⁵_{g}R¹_{d}Si(R²)_{4-d-g} (11)

where R⁵ is E-(CR³₂)ₕ—W—(CH₂)ₕ—; R¹, R², and d are as described above; g is 1 or 2; d+g=1 to 2; and h is 0 to 8, and may be identical or different.
Non-limiting examples of suitable compounds include:

E¹-(CR³₂)ₕ—W—(CH₂)ₕ—SiR¹_{d}(R²)_{3-d} (11a) or (11d)

E²-[(CR³₂)ₕ—W—(CH₂)ₕ—SiR¹_{d}(R²)_{3-d}]ⱼ (11b) or (11f)

where j is 2 to 3.

The group E may be selected from either a group E¹ or E². E¹ may be selected from a monovalent group comprising amine, —NH₂, —NHR, —(NHC₂H₅)ₐNHR, NHC₆H₅, halogen, pseudo pseudohalogen, unsaturated aliphatic group with up to 14 carbon atoms, epoxy-group-containing aliphatic group with up to 14 carbon atoms, cyanurate-containing group, and an isocyanurate-containing group.

E² may be selected from a group comprising a di- or multivalent group consisting of amine, polyamine, cyanurate-containing, and an isocyanurate-containing group, sulfide, sulfate, phosphate, phosphite, and a polyorganosiloxane group, which can contain R⁵ and R² groups; W is selected from the group consisting of a single bond, a heteroatomic group selected from —COO—, —O—, epoxy, —S—, —CONH—, —HN—CO—NH— units; R³ is as defined above, R¹ may be identical or different as defined above, R² is defined as above and may be identical or different.

Non-limiting examples of component (D) include:

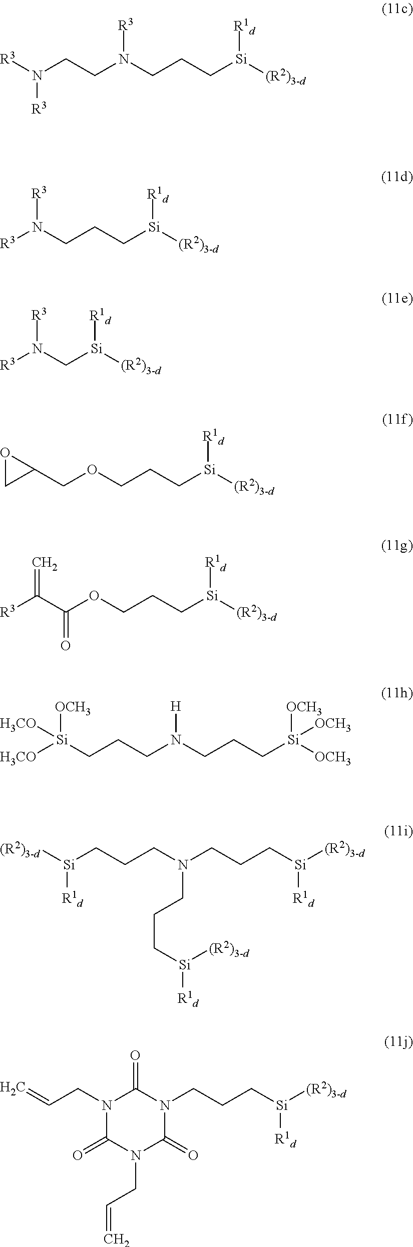

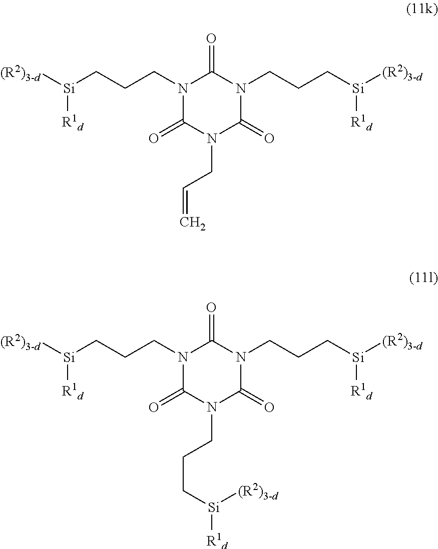

wherein R¹, R², and d are as defined above. Examples of component (D) include compounds of the formulas (7a-7l). Furthermore the formula (7b) of compounds (D) shall comprise compounds of the formula (7m):

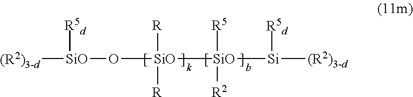

wherein: R, R², R⁵, and d are as defined above; k is 0 to 6 (and in one embodiment desirably 0); b is as described above (in one embodiment desirably 0 to 5); and 1+b≦10. In one embodiment, R⁵ is selected from:

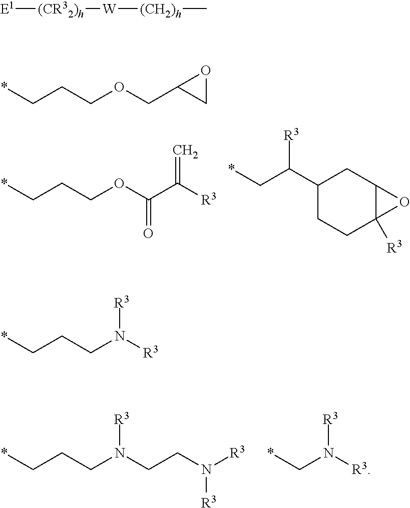

An exemplary group of adhesion promoters are selected from the group that consists of amino-group-containing silane coupling agents. The amino-group-containing silane adhesion promoter agent (D) is an acidic compound having a group containing a silicon atom bonded to a hydrolyzable group (hereinafter referred to as a hydrolyzable group attached to the silicon atom) and an amino group. Specific examples thereof include the same silyl groups with hydrolyzable groups described above. Among these groups, the methoxy group and ethoxy group are particularly suitable. The number of the hydrolyzable groups may be 2 or more, and particularly suitable are compounds having 3 or more hydrolyzable groups.

Examples of other suitable adhesion promoter (D) include, but are not limited to N-(2-aminoethyl)aminopropyltrimethoxysilane, gamma-aminopropyltriethoxysilane, gamma-aminopropyltrimethoxysilane, bis(3-trimethoxysilypropyl)amine, N-phenyl-gamma-aminopropyltrimethoxysilane, triaminofunctionaltrimethoxysilane, gamma-aminopropylmethyldimethoxysilane, gamma-aminopropylmethyldiethoxysilane, methacryloxypropyltrimethoxysilane, methylaminopropyltrimethoxysilane, gamma-glycidoxypropylethyldimethoxysilane, gamma-glycidoxypropyltrimethoxysilane, gamma-glycidoxyethyltrimethoxysilane, gamma-glycidoxypropylmethyldimethoxysilane, gamma-glycidoxypropylmethyldiethoxysilane, beta-(3,4-epoxycyclohexyl)ethyltrimethoxysilane, beta-(3,4-epoxycyclohexyl)ethylmethyldimethoxysilane, beta-(3,4-epoxycyclohexyl)ethyltriethoxysilane, beta-(3,4-epoxycyclohexyl)ethylmethyldiethoxysilane, epoxylimonyltrimethoxysilane, isocyanatopropyltriethoxysilane, isocyanatopropyltrimethoxysilane, isocyanatopropylmethyldimethoxysilane, beta-cyanoethyltrimethoxysilane, gamma-acryloxypropyltrimethoxysilane, gamma-methacryloxypropylmethyldimethoxysilane, alpha, omega-bis(aminoalkyldiethoxysilyl)polydimethylsiloxanes (Pn=1-7), alpha, omega-bis(aminoalkyldiethoxysilyl)octamethyltetrasiloxane, 4-amino-3,3-dimethylbutyltrimethoxysilane, N-ethyl-3-trimethoxysilyl-2-methylpropanamine and 3-(N,N-diethylaminopropyl)trimethoxysilane combinations of two or more thereof, and the like.

Also it is possible to use derivatives obtained by modifying them, for example, amino-modified silyl polymer, silylated amino polymer, unsaturated aminosilane complex, phenylamino long-chain alkyl silane and aminosilylated silicone. These amino-group-containing silane coupling agents may be used alone, or two or more kinds of them may be used in combination.

The adhesion promoter (D) may be present in an amount of from about 0.1 to about 5.0 pt. wt. based on 100 parts of the polymer component (A). In one embodiment, the adhesion promoter may be present in an amount of from about 0.15 to about 2.0 pt. wt. based on 100 parts of the polymer component (A). In another embodiment, the adhesion promoter may be present in an amount of from about 0.5 to about 1.5 pt. wt of the polymer component (A). This defines the amount of (D) in composition of (A) wherein the content of free silanes coming from the endcapping of polymer (A) is smaller than 0.1 wt. %.

The present compositions may further include a filler component (E). The filler component(s) (E) may have different functions, such as to be used as reinforcing or semi-reinforcing filler, i.e., to achieve higher tensile strength after curing. The filler component may also have the ability to increase viscosity, establish pseudoplasticity/shear thinning, and demonstrate thixotropic behavior. Non-reinforcing fillers may act as volume extenders. The reinforcing fillers are characterized by having a specific surface area of more than 50 m²/g related BET-surface, whereby the semi-reinforcing fillers have a specific surface area in the range of 10-50 m²/g. So-called extending fillers have preferably a specific surface area of less than 10 m²/g according to the BET-method and an average particle diameter below 100 μm. In one embodiment, the semi-reinforcing filler is a calcium carbonate filler, a silica filler, or a mixture thereof. Examples of suitable reinforcing fillers include, but are not limited to, fumed silicas or precipitated silicas, which can be partially or completely treated with organosilanes or siloxanes to make them less hydrophilic and decrease the water content or control the viscosity and storage stability of the composition. These fillers are named hydrophobic fillers. Tradenames are Aerosil®, HDK®, Cab-O-Sil® etc.

Examples of suitable extending fillers include, but are not limited to, ground silicas (Celite™), precipitated and colloidal calcium carbonates (which are optionally treated with compounds such as stearate or stearic acid); reinforcing silicas such as fumed silicas, precipitated silicas, silica gels and hydrophobized silicas and silica gels; crushed and ground quartz, cristobalite, alumina, aluminum hydroxide, titanium dioxide, zinc oxide, diatomaceous earth, iron oxide, carbon black, powdered thermoplastics such as acrylonitrile, polyethylene, polypropylene, polytetrafluoroethylene and graphite or clays such as kaolin, bentonite or montmorillonite (treated/untreated), and the like.

The type and amount of filler added depends upon the desired physical properties for the cured silicone/non-silicone composition. As such, the filler may be a single species or a mixture of two or more species. The extending fillers can be present from about 0 to about 300 wt. % of the composition related to 100 parts of component (A). The reinforcing fillers can be present from about 5 to about 60 wt. % of the composition related to 100 parts of component (A), preferably 5 to 30 wt. %.

The inventive compositions optionally comprise an acidic compound (F), which, in conjunction with the adhesion promoter and diazabicyclic catalyst, can accelerate curing (as compared to curing in the absence of such compounds). The component (F) may be present in an amount of from about 0.01 to about 5 wt. % of the composition. In another embodiment 0.01 to about 8 parts per weight (pt. wt.) per 100 pt. wt. of component (A) are used, more preferably 0.02 to 3 pt. wt. per 100 pt. wt. of component (A) and most preferably 0.02 to 1 pt. wt. per 100 pt. wt. of component (A) are used.

The acidic compounds (F) may be chosen from various phosphate esters, phosphonates, phosphites, phosphonites, sulfites, sulfates, pseudo halogenides, branched alkyl carboxylic acids, combinations of two or more thereof, and the like. Without being bound to any particular theory, the acidic compounds (F) may, in one embodiment, be useful as stabilizers in order to ensure a longer storage time when sealed in a cartridge before use in contact with ambient air. Especially alkoxy-terminated polysiloxanes can lose the ability to cure after storage in a cartridge and show decreased hardness under curing conditions. It may, therefore be useful to add compounds of the formula (8), which can extend storage time or ability to cure over months.

O═P(OR⁶)_{3-c}(OH)_{c} (8)

whereby c is as defined above; and R⁶ is selected from the group of linear or branched and optionally substituted C₁-C₃₀ alkyl groups, linear or branched C₅-C₁₄ cycloalkyl groups, C₆-C₁₄ aryl groups, C₆-C₃₁ alkylaryl groups, linear or branched C₂-C₃₀ alkenyl groups or linear or branched C₁-C₃₀ alkoxyalkyl groups, C₄-C₃₀₀ polyalkenylene oxide groups (polyethers), such as Marlophor® N5 acid, triorganylsilyl- and diorganyl (C₁-C₈)-alkoxysilyl groups. The phosphates can include also mixtures of primary and secondary esters. Non-limiting examples of suitable phosphonates include 1-hydroxyethane-(1,1-diphosphonic acid) (HEDP), aminotris(methylene phosphonic acid) (ATMP), diethylenetriaminepenta(methylene phosphonic acid) (DTPMP), 1,2-diaminoethane-tetra(methylene phosphonic acid) (EDTMP), and phosphonobutanetricarboxylic acid (PBTC).

In another embodiment, a compound of the formula O═P(OR⁷)_{3-g}(OH)_{g} may be added where g is 1 or 2, and R⁷ is defined as R⁶ or di- or multivalent hydrocarbons with one or more amino group.

Another type are phosphonic acid compounds of the formula R⁶P(O)(OH)₂ such as alkyl phosphonic acids preferably hexyl or octyl phosphonic acid.

In one embodiment, the acidic compound may be chosen from a mono ester of phosphoric acid of the formula (R⁸O)PO(OH)₂; a phosphonic acid of the formula R⁸P(O)(OH)₂; or a monoester of phosphorous acid of the formula (R⁸O)P(OH)₂ where R⁸ is a C₁-C₁₈ alkyl, a C₂-C₂₀ alkoxyalkyl, phenyl, a C₇-C₁₂ alkylaryl, a C₂-C₄ polyalkylene oxide ester or its mixtures with diesters, etc.

In another embodiment, the acidic compound is a branched C₄-C₃₀ alkyl carboxylic acids, including C₅-C₁₉ acids with an alpha tertiary carbon, or a combination of two or more thereof. Examples of such suitable compounds include, but are not limited to, Versatic™ Acid, lauric acid, and stearic acid. In one embodiment, the acidic compound may be a mixture comprising branched alkyl carboxylic acids. In one embodiment, the acidic compound is a mixture of mainly tertiary aliphatic C₁₀ carboxylic acids.

Generally, the acidic component (F) is added in a molar ratio of less than or equal to 1 with respect to catalyst (C). In embodiments, the acidic component (F) is added in a molar ratio of (F):(C) of 1:15 to 1:1.

The curable composition may also include auxiliary substances (G) such as plastizers, pigments, stabilizers, anti-microbial agents, fungicides, biocides, and/or solvents. Preferred plastizers for reactive polyorganosiloxanes (A) are selected from the group of polyorganosiloxanes having chain lengths of 10 to 300 siloxy units. Preferred are trimethylsilyl terminated polydimethylsiloxanes having a viscosity of 100 to 1000 mPa·s at 25° C. The choice of optional solvents (dispersion media or extenders) may have a role in assuring uniform dispersion of the catalyst, thereby altering curing speed. Such solvents include polar and non-polar solvents such as toluene, hexane, chloroform, methanol, ethanol, isopropyl alcohol, acetone, methylethyl ketone, dimethylformamide (DMF), dimethyl sulfoxide (DMSO), N-methylpyrrolidinone (NMP), and propylene carbonate. Water can be an additional component (G) to accelerate fast curing 2-part compositions RTV-2, whereby the water can be in one part of the 2 compositions. Particularly suitable non-polar solvents include, but are not limited to, toluene, hexane, and the like if the solvents should evaporate after cure and application. In another embodiment, the solvents include high-boiling hydrocarbons such as alkylbenzenes, phtalic acid esters, arylsulfonic acid esters, trialkyl- or triarylphosphate esters, which have a low vapor pressure and can extend the volume providing lower costs. Examples cited by reference may be those of U.S. Pat. No. 6,599,633; U.S. Pat. No. 4,312,801. The solvent can be present in an amount of from about 20 to about 99 wt. % of the catalyst composition.

Applicants have found that present catalysts can provide a curable composition that yields a cured polymer exhibiting a tack-free time, hardness, and/or cure time comparable to compositions made using tin catalysts, but that provide better adhesion compared to materials made using tin or other metal catalysts.

In one embodiment, a composition in accordance with the present invention comprises: 100 pt. wt. polymer component (A); about 0.1 to about 10 pt. wt. crosslinker component (B); and about 0.01 to about 7 pt. wt. catalyst component (C). In one embodiment, the composition further comprises from about 0.1 to about 5, in one embodiment 0.15 to 1 pt. wt., of an adhesion promoter component (D); about 0 to about 300 pt. wt. filler component (E); about 0.01 to about 7 pt. wt. of acidic compound (F); optionally 0 to about 15 pt. wt. component (G), where the pt. wt. of components (B)-(G) are each based on 100 parts of the polymer component (A). In one embodiment, the composition comprises the component (F) in an amount of from about 0.01 to about 1 pt. wt. per 100 pt. wt. of component (A). In still another embodiment, the composition comprises the catalyst (C) in an amount of from about 0.1 to about 0.8 wt. pt. per 100 wt. pt of component (A).

It will be appreciated that the curable compositions may be provided as either a one-part composition or a two-part composition. A one-part composition refers to a composition comprising a mixture of the various components described above. A two-part composition may comprise a first portion and a second portion that are separately stored and subsequently mixed together just prior to application for curing. In one embodiment, a two-part composition comprises a first portion (P1) comprising a polymer component (A) and a crosslinker component (B), and a second portion (P2) comprising the catalyst component (C) comprising a diazabicyclic compound. The first and second portions may include other components (D) and/or (E) and/or (F) and/or (G) as may be desired for a particular purpose or intended use. For example, in one embodiment, the first portion (P1) may optionally comprise an adhesion promoter (D) and/or a filler (E), and the second portion (P2) may optionally comprise auxiliary substances (G), a cure rate modifying component (F), and water (G).

In one embodiment, a two-part composition comprises (i) a first portion comprising the polymer component (A), optionally the filler component (E), and optionally the acidic compound (F); and (ii) a second portion comprising the crosslinker (B), the catalyst component (C), the adhesive promoter (D), and the acidic compound (F), where portions (i) and (ii) are stored separately until applied for curing by mixing of the components (i) and (ii).

An exemplary two-part composition comprises: a first portion (i) comprising 100 pt. wt. of component (A), and 0 to 70 pt. wt. of component (E); and a second portion (ii) comprising 0.1 to 5 pt. wt. of at least one crosslinker (B); 0.01 to 4 pt. wt. of a catalyst (C); 0.1 to 2 pt. wt. of an adhesion promoter (D); and optionally, 0.02 to 1 pt. wt. component (F).

The curable compositions may be used in a wide range of applications including as materials for sealing, mold making, glazing, proto-typing, as adhesives, as coatings, as joint seal between different materials, e.g., sealants between ceramic or mineral surfaces and thermoplastics, as paper release, as impregnation materials, and the like. A curable composition in accordance with the present invention comprising an amidine compound as a catalyst may be suitable for a wide variety of applications such as, for example, a general purpose and industrial sealant, potting compound, caulk, adhesive or coating for construction use, insulated glass, structural glazing, where glass sheets are fixed and sealed in metal frame; caulks, adhesives for metal plates, car bodies, vehicles, electronic devices, and the like. Furthermore, the present composition may be used either as a one-part RTV-1 or as a two-part RTV-2 formulation that can adhere onto broad variety of metal, mineral, ceramic, rubber, or plastic surfaces.

Curable compositions comprising amidine catalyst compounds may be further understood with reference to the following Examples.

### Examples

To a mixture of 1 g of ethylpolysilicate (EPS), 0.5 g of adhesion promoter and catalyst (0.4 g), 99.66 g of a mixture of OH-end capped PDMS, silica filler, and low molecular weight OH-end capped PDMS is added and mixed using a Hauschild mixer for 1.5 min. The mixed formulation is poured into a Teflon mold (length×breadth×depth˜10 cm×10 cm×1 cm) and placed inside a fume hood. The surface curing (TFT) and bulk curing are monitored as a function of time (maximum of 7 days).

The surface cure is denoted by tack free time (TFT). In a typical TFT measurement, a stainless steel (SS) weight (weighing ˜10 g) is placed on the surface of the formulation spread on the Teflon mold to infer the tackiness of the surface as whether any material is adhered to the surface of the SS weight or not. TFT is defined as the time taken for getting a non-tacky surface. Bulk curing is the time taken for complete curing of formulation throughout the thickness (i.e. Top to bottom) and it is monitored as a function of time (visual inspection).

For aging studies, the pre-mixed mixture containing ethylpolysilicate (EPS), adhesion promoter, catalyst, and cure accelerator or storage stabilizer are kept in an oven for (1) 4 hours at 50° C., or (2) 5 days at 70° C., after which time the mixture is removed from the oven and allow to cool to room temperature. The mixture is then mixed with a mixture of OH-end capped PDMS, silica filler, and low molecular weight OH-end capped PDMS using a Hauschild mixer for 1.5 min. The mixed formulation is poured into a Teflon mold (length×breadth×depth˜10 cm×10 cm×1 cm) and placed inside a fume hood. The surface curing (TFT) and bulk curing are monitored as a function of time (maximum of 7 days) and Shore A hardness in order to determine to what extent the compositions maintain performance after storage under accelerated conditions. The increased temperature for the storage test is indicative of the long-term storage stability of the composition at room temperature (25° C. and 50-60% relative humidity).

Table 1 illustrates the TFT, bulk cure and hardness properties of compositions employing a diazobicyclo compound as a catalyst with and without adhesion promoters. Table 2 illustrates the TFT, bulk cure, hardness and adhesion properties of a diazabicyclic compound with different adhesion promoters.

TABLE 1

| Comp | Example | Example | Example | Example | Example | Example | Example |
|---|---|---|---|---|---|---|---|
| Ex-1 | 1 | 2 | 3 | 4 | 5 | 6 | 7 |

Component A

| | | | | | | | | |
|---|---|---|---|---|---|---|---|---|
| OH-end capped PDMS | 52.8 | 52.8 | 52.8 | 52.8 | 52.8 | 52.58 | 52.8 | 52.8 |
| (Viscosity ~4 Pa · s) | | | | | | | | |
| OH-end capped PDMS | 20 | 20 | 20 | 20 | 20 | 20 | 20 | 20 |
| (3500 cps) | | | | | | | | |
| Silica | 26.4 | 26.4 | 26.4 | 26.4 | 26.4 | 26.4 | 26.4 | 26.4 |

Component B

| | | | | | | | | |
|---|---|---|---|---|---|---|---|---|
| Ethyl polysilicate | 1 | 1 | 1 | 1 | 1 | 1 | 1 | 1 |
| N-β(Aminoethyl)-y- | 0.5 | | | | 0.5 | 0.5 | 0.5 | 0.5 |
| aminoproply- | | | | | | | | |
| trimethoxysilane (D1)) | | | | | | | | |
| Dibutyltin dilaurate | 0.1 | | | | | | | |
| 1,8 DIAZABICYCLO | | 0.5 | | | 0.5 | | | 0.1 |
| (5,4,O) UNDEC-7-ENE | | | | | | | | |
| (6674-22-2) | | | | | | | | |
| 1,4 | | | 0.5 | | | 0.5 | | |
| DIAZABICYCLO(2,2,2) | | | | | | | | |
| OCTANE (280-57-9) | | | | | | | | |
| 1,5 Diazabicyclo[4.3.0] | | | | 0.5 | | | 0.5 | |
| non-5-ene (3001-72-7) | | | | | | | | |
| 1,8 DIAZABICYCLO | | | | | | | | |
| (5,4,O) UNDEC-7-ENE | | | | | | | | |
| and p-toluene sulfonic | | | | | | | | |
| acid (1:1) | | | | | | | | |
| Versatic acid | | | | | | | | |

Properties

| | | | | | | | | |
|---|---|---|---|---|---|---|---|---|
| Tack-free time (min) - | 14 | 7 | 270 | 5 | 4 | 42 | 4 | 15 |
| RT | | | | | | | | |
| Bulk cure | 7 | 7 | 24 | 7 | 5 | 7 | 5 | 6 |
| Shore-A Hardness | 50/30 | 41/40 | 38/32 | 45/42 | 35/32 | 28/10 | 33/30 | 46/43 |
| (top/bottom)- | | | | | | | | |
| immediately after curing | | | | | | | | |

| | | | | | |
|---|---|---|---|---|---|
| Example | Example | Example | Example | Example | Example |
| 8 | 9 | 10 | 11 | 12 | 13 |

Component A

| | | | | | | |
|---|---|---|---|---|---|---|
| OH-end capped PDMS | 52.8 | 52.8 | 52.8 | 52.8 | 52.58 | 52.58 |
| (Viscosity ~4 Pa · s) | | | | | | |
| OH-end capped PDMS | 20 | 20 | 20 | 20 | 20 | 20 |
| (3500 cps) | | | | | | |
| Silica | 26.4 | 26.4 | 26.4 | 26.4 | 26.4 | 26.4 |

Component B

| | | | | | | |
|---|---|---|---|---|---|---|
| Ethyl polysilicate | 1 | 1 | 1 | 1 | 1 | 1 |
| N-β(Aminoethyl)-y- | 0.5 | 0.5 | 0.5 | 0.5 | 0.5 | 0.5 |
| aminoproply- | | | | | | |
| trimethoxysilane (D1)) | | | | | | |
| Dibutyltin dilaurate | | | | | | |
| 1,8 DIAZABICYCLO | | | 0.3 | 0.2 | | |
| (5,4,O) UNDEC-7-ENE | | | | | | |
| (6674-22-2) | | | | | | |
| 1,4 | 0.1 | | | | 0.5 | |
| DIAZABICYCLO(2,2,2) | | | | | | |
| OCTANE (280-57-9) | | | | | | |
| 1,5 Diazabicyclo[4.3.0] | | 0.1 | | | | |
| non-5-ene (3001-72-7) | | | | | | |
| 1,8 DIAZABICYCLO | | | | | | 0.5 |
| (5,4,O) UNDEC-7-ENE | | | | | | |
| and p-toluene sulfonic | | | | | | |
| acid (1:1) | | | | | | |
| Versatic acid | | | | | 0.03 | |

Properties

| | | | | | | |
|---|---|---|---|---|---|---|
| Tack-free time (min) - | 71 | 16 | 6 | 12 | 22 | 23 |
| RT | | | | | | |
| Bulk cure | 10 | 6 | 5 | 5 | 18 | 16 |
| Shore-A Hardness | 25/5 | 48/36 | 45/38 | 48/45 | NA | NA |
| (top/bottom)- | | | | | | |
| immediately after curing | | | | | | |

TABLE 2

| Comp | Example | Example | Example | Example | Example |
|---|---|---|---|---|---|
| Ex-1 | 14 | 15 | 16 | 17 | 18 |

Component A

| | | | | | | |
|---|---|---|---|---|---|---|
| OH-end capped PDMS (Viscosity ~4 Pa · s) | 52.8 | 52.8 | 52.8 | 52.8 | 52.8 | 52.8 |
| OH-end cappedPDMS (3500 cps) | 20 | 20 | 20 | 20 | 20 | 20 |
| Silica | 26.4 | 26.4 | 26.4 | 26.4 | 26.4 | 26.4 |

Component B

| | | | | | | |
|---|---|---|---|---|---|---|
| Ethyl polysilicate | 1 | 1 | 1 | 1 | 1 | 1 |
| N-β (Aminoethyl)-γ-aminopropyl- | 0.5 | 0.5 | | | | 0.5 |
| trimethoxysilane (D1) | | | | | | |
| 3-Aminopropyltrimethoxy silane (D2) | | | 0.5 | | | 0.5 |
| 3-Glycidoxypropyltrimethoxy silane (D3) | | | | 0.5 | | |
| Tris(trimethoxysilylpropyl)isocyanurate | | | | | 0.5 | 0.5 |
| (D4) | | | | | | |
| Dibutyltin dilaurate | 0.1 | | | | | |
| 1,8 DIAZABICYCLO (5,4,O)UNDEC-7- | | 0.25 | 0.25 | 0.25 | 0.25 | 0.25 |
| ENE(6674-22-2) | | | | | | |

Cure and hardness properties- After aging Component B at 50° C. for 4 hours

| | | | | | | |
|---|---|---|---|---|---|---|
| Tack-free time (min) | 11 | 12 | 10 | 12 | 8 | 15 |
| Bulk-cure time (h) | 7 | 5 | 5 | 5 | 6 | 8 |
| Shore-A hardness (top/bottom)-immediately | 50/42 | 40/30 | 40/22 | 45/32 | 52/43 | 32/10 |
| after curing | | | | | | |
| Shore-A hardness (top/bottom) -After 2 days | 50/46 | 46/42 | 42/34 | 48/39 | 52/46 | 44/36 |

Adhesion onto different substrates- After aging Component-B at 50° C. for 4 hours

| | | | | | | |
|---|---|---|---|---|---|---|
| Cu | x | ∘ | ∘ | x | x | ∘ |
| Al | x | ∘ | ∘ | x | x | ∘ |
| Glass | x | x | ∘ | ∘ | ∘ | ∘ |
| Epoxy glass | ∘ | x | ∘ | ∘ | ∘ | ∘ |
| Polycarbonate (PC) | ∘ | x | ∘ | ∘ | ∘ | ∘ |
| Polyvinyl chloride (PVC) | x | x | x | ∘ | ∘ | ∘ |
| Polybutylene terephthalate (PBT) | x | x | x | x | ∘ | ∘ |
| Noryl ® | x | ∘ | x | x | x | ∘ |

Cure and hardness properties- After aging Component B at 70° C. for 5 days

| | | | | | | |
|---|---|---|---|---|---|---|
| Tack-free time (min) | 10 | 10 | 8 | 1 | 50 | 20 |
| Bulk cure time (h) | 4 | 3 | 3 | 3 | 10 | 6 |
| Hardness (top/bottom) (24 hours after curing) | 53/48 | 41/42 | 41/41 | 42/28 | 25/20 | 36/12 |

Adhesion onto different substrates - After aging Component-B at 70° C. for 5 days

| | | | | | | |
|---|---|---|---|---|---|---|
| Cu | ∘ | ∘ | ∘ | * | x | ∘ |
| Al | ∘ | ∘ | ∘ | * | x | ∘ |
| Glass | ∘ | ∘ | ∘ | * | ∘ | ∘ |
| Epoxy glass | ∘ | ∘ | ∘ | * | ∘ | ∘ |
| Polycarbonate (PC) | ∘ | ∘ | ∘ | * | x | ∘ |
| Polyvinyl chloride (PVC) | x | x | x | * | ∘ | ∘ |
| Polybutylene terephthalate (PBT) | x | x | x | * | x | ∘ |
| Noryl ® | x | x | x | * | x | ∘ |

x - No adhesion
∘ - Good adhesion
*- Adhesion testing could not be performed as the composition cures rapidly

Examples 1-6 and the comparative example C1 show the cure and hardness characteristics of different amidine catalysts (at 0.5 wt % loading), both with and without an adhesion promoter (D1), in comparison to that of tin catalyst (0.1 wt %) with an adhesion promoter (D1). The results obtained with different diazobicyclo compounds at the loading similar to that of tin catalysts in Examples 7-9. Examples 10 and 11 show that the variation of catalytic activity with varying loading levels of amidine compounds. Example 12 shows the synergistic influence of versatic acid along with diazobicyclic compounds on curing, as compared to working example-5 (without versatic acid). Example 12 shows cure characteristics of amidine salt. Examples 14 to 18 shows the effect of using different adhesion promoter along with DBU—indicating that the cure performance of DBU remain similar when used along with different adhesion promoters. Improved adhesion of moisture cured silicone compositions onto variety of substrates with the use of DBU along with different adhesion promoters and their combinations is also evident.

Embodiments of the invention have been described above and modifications and alterations may occur to others upon the reading and understanding of this specification. The claims as follows are intended to include all modifications and alterations insofar as they come within the scope of the claims or the equivalent thereof.

We claim:

1. A composition for forming a cured polymer composition comprising:
(A) a polymer having at least a reactive silyl group;
(B) a crosslinker or chain extender;
(C) a catalyst comprising a diazabicyclic compound or a salt thereof; and
(D) an optional adhesion promoter.

2. The composition of claim 1, wherein the diazabicyclic compound comprises an amidine linkage.

3. The composition of claim 1, wherein the diazabicyclic compound is chosen from a compound of the formula: 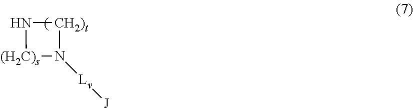
where s is an integer from 1 to 8, t is 0 or an integer from 1 to 4; J is a cyclic compound; L is a linking group, and v is 0-10; 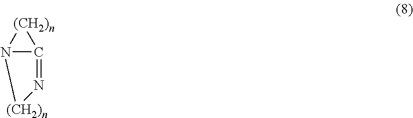
where n is an integer from 1-10; 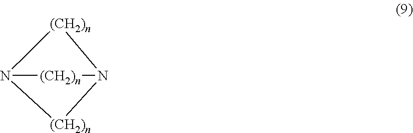
where n is an integer from 1-10; and 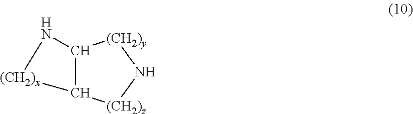
where x is an integer from 1-10, y is an integer from 0-10, and z is an integer from 0-10, where at least one of y and/or z is at least 1; or a combination of two or more thereof.

4. The composition of claim 3 comprising a compound of formula (4), wherein the L group is chosen from —O—; —COO—; —S—; —CONH—; —HN—CO—NH—; alkyl; alkene; aryl; epoxy; aryl group containing a heteroatomic group chosen from —O—, —COO—, —S—, —CONH—, —HN—CO—NH—, epoxy; or a combination of two or more thereof.

5. The composition of claim 1, wherein the catalyst comprises a diazabicyclic compound of the formula:

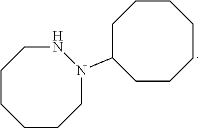 [SMILES: C1CCCC(N2CCCCCCN2)CCC1]

6. The composition of claim 1, wherein the catalyst comprises a bicyclic compound comprising (a) a first cyclic group comprising a diaza functional moiety, and (b) a second cyclic group attached to the first cyclic group.

7. The composition of claim 6, wherein the first cyclic group is chosen from diaziridine, diazetidine, imidazolidine, perazine, diazepane, and diazocane, and the second cyclic group is chosen from a cycloaliphatic group, an aryl, a heterocycle, and a heteroaryl.

8. The composition of claim 6, wherein the second cyclic group is chosen from a C₃-C₁₀ cycloaliphatic group, a C₆-C₁₀ aryl group, a 3-10 membered heterocycle, or a 6-10 membered heteroaryl.

9. The composition of claim 1, wherein the diazabicyclic compound is chosen from 1,5-diazabicyclo[4.2.0]oct-5-ene; 1,5-diazabicyclo[4.3.0]non-5-ene; 1,5-diaza-3,methylbicyclo[4.3.0]non-5-ene; 1,5-diazabicyclo[4.4.0]dec-5-ene; 1,5-diaza-10-methylbicyclo[4.4.0]dec-5-ene; 1,8-diazabicycl[5.4.0]undec-7-ene (hereinafter referred to as DBU); 1,9-diazabicyclo[6.4.0]dodec-8-ene; 1,10-diazabicyclo[7.4.0]tridec-9-ene; 1,14-diazabicyclo[11.4.0]heptadec-13-ene; 6-dibutylamino-1,8-diazabicyclo[5,4,0]undec-7-ene; 1,4-diazabicyclo[2,2,2]octane; 2,6-diazabicyclo[3.2.0]heptane; 3,6-diazabicyclo[3.2.0]heptane; 2,7-diazabicyclo[4.2.0]octane; 3,7-diazabicyclo[4.2.0]octane; 2,8-diazabicyclo[4.2.0]octane; 2,6-diazabicyclo[3.3.0]octane; 2,7-diazabicyclo[3.3.0]octane; 2,7-diazabicyclo[4.3.0]octane; 2,8-diazabicyclo[4.3.0]nonane; 3,7-diazabicyclo[4.3.0]nonane; 3,8-diazabicyclo[4.3.0]nonane; 3,9-diazabicyclo[4.3.0]nonane; 2,6-diazabicyclo[3.2.1]octane; 3,6-diazabicyclo[3.2.1]octane, or a combination of two or more thereof.

10. The composition of any of claim 1, wherein the catalyst composition (C) comprises a mixture of a salt of a diazabicyclic compound and a sulfonic acid.

11. The composition of any of claim 1 comprising from about 0.01 to about 7 parts per weight of catalyst (C) per 100 parts per weight of the polymer (A).

12. The composition of any of claim 1, wherein the polymer (A) has the formula (2)
[R¹ₐR²₃₋ₐSi—Z—]ₙ—X—Z—SiR¹ₐR²₃₋ₐ (2)
where X is chosen from a polyurethane; a polyester; a polyether; a polycarbonate; a polyolefin; a polyester ether; and a polyorganosiloxane having units of R₃SiO_{1/2}, R₂SiO, RSiO_{3/2}, and/or SiO₂,
n is 0 to 100,
a is 0 to 2,
R and R¹ can be identical or different at the same Si-atom and chosen from a C₁-C₁₀ alkyl; a C₁-C₁₀ alkyl substituted with one or more of Cl, F, N, O or S; a phenyl; a C₇-C₁₆ alkylaryl; a C₇-C₁₆ arylalkyl; a C₂-C₄ polyalkylene ether; or a combination of two or more thereof.
R² is chosen from OH, C₁-C₈ alkoxy, C₂-C₁₈ alkoxyalkyl, oximoalkyl, enoxyalkyl, aminoalkyl, carboxyalkyl, amidoalkyl, amidoaryl, carbamatoalkyl, or a combination of two or more thereof, and
Z is a bond, a divalent unit selected from the group of a C₁-C₈ alkylene, or O.

13. The composition of any of claim 1, wherein the crosslinker component (B) is chosen from tetraethylorthosilicate (TEOS); methyltrimethoxysilane (MTMS); methyltriethoxysilane; vinyltrimethoxysilane; vinyltriethoxysilane; methylphenyldimethoxysilane; 3,3,3-trifluoropropyltrimethoxysilane; methyltriacetoxysilane; vinyltriacetoxysilane; ethyltriacetoxysilane; di-butoxydiacetoxysilane; phenyltripropionoxysilane; methyltris(methylethylketoximo)silane; vinyltris(methylethylketoximo)silane; 3,3,3-trifluoropropyltris(methylethylketoximo)silane; methyltris(isopropenoxy)silane; vinyltris(isopropenoxy)silane; ethylpolysilicate; dimethyltetraacetoxydisiloxane; tetra-n-propylorthosilicate; methyldimethoxy(ethylmethylketoximo)silane; methylmethoxybis(ethylmethylketoximo)silane; methyldimethoxy(acetaldoximo)silane; methyldimethoxy(N-methylcarbamato)silane; ethyldimethoxy(N-methylcarbamato)silane; methyldimethoxyisopropenoxysilane; trimethoxyisopropenoxysilane; methyltriisopropenoxysilane; methyldimethoxy(but-2-en-2-oxy)silane; methyldimethoxy(1-phenylethenoxy)silane; methyldimethoxy-2-(1-carboethoxypropenoxy)silane; methylmethoxydi(N-methylamino)silane; vinyldimethoxy(methylamino)silane; tetra-N,N-diethylaminosilane; methyldimethoxy(methylamino)silane; methyltri(cyclohexylamino)silane; methyldimethoxy(ethylamino)silane; dimethyldi(N,N-dimethylamino)silane; methyldimethoxy(isopropylamino)silane; dimethyldi(N,N-diethylamino)silane; ethyldimethoxy(N-ethylpropionamido)silane; methyldimethoxy(N-methylacetamido)silane; methyltris(N-methylacetamido)silane; ethyldimethoxy(N-methylacetamido)silane; methyltris(N-methylbenzamido)silane; methylmethoxybis(N-methylacetamido)silane; methyldimethoxy(caprolactamo)silane; trimethoxy(N-methylacetamido)silane; methyldimethoxy(ethylacetimidato)silane; methyldimethoxy(propylacetimidato)silane; methyldimethoxy(N,N′,N′-trimethylureido)silane; methyldimethoxy(N-allyl-N′,N′-dimethylureido)silane; methyldimethoxy(N-phenyl-N′,N′-dimethylureido)silane; methyldimethoxyisocyanatosilane; dimethoxydiisocyanatosilane; methyldimethoxyisothiocyanatosilane; methylmethoxydiisothiocyanatosilane, or a combination of two or more thereof.

14. The composition of any of claim 1 comprising two or more adhesion promoters.

15. The composition of any of claim 1, wherein the adhesion promoter component (D) is chosen from an (aminoalkyl)trialkoxysilane, an (aminoalkyl)alkyldialkoxysilane, a bis(trialkoxysilylalkyl)amine, a tris(trialkoxysilylalkyl)amine, a tris(trialkoxysilylalkyl)cyanurate, and a tris(trialkoxysilylalkyl)isocyanurate, an (epoxyalkyl)alkyldialkoxysilane, an (epoxyalkyl)trialkoxysilane, or a combination of two or more thereof.

16. The polymer composition of any of claim 1 wherein the polymer component (A) has the formula (4):
R²₃₋ₐR¹ₐSi—Z—[R₂SiO]ₓ[R¹₂SiO]_{y}—Z—SiR¹ₐR²₃₋ₐ (4)
whereby
x is 0 to 10000;
y is 0 to 1000;
a is 0 to 2;
R is methyl;
R¹ is chosen from a C₁-C₁₀ alkyl; a C₁-C₁₀ alkyl substituted with one or more of Cl, F, N, O, or S; a phenyl; a C₇-C₁₆ alkylaryl; a C₇-C₁₆ arylalkyl; a C₂-C₄ polyalkylene ether; or a combination of two or more thereof, and other siloxane units may be present in amounts less than 10 mol. %;
R² is chosen from OH, a C₁-C₈ alkoxy, a C₂-C₁₈ alkoxyalkyl, an oximoalkyl, an oximoaryl, an enoxyalkyl, an enoxyaryl, an aminoalkyl, an aminoaryl, a carboxyalkyl, a carboxyaryl, an amidoalkyl, an amidoaryl, a carbamatoalkyl, a carbamatoaryl, or a combination of two or more thereof; and
Z is —O—, a bond, or —C₂H₄—.

17. The composition of any of claim 1, wherein the composition is provided as a one part composition.

18. The composition of any of claim 1, wherein the composition is provided as a two part composition comprising a first portion (P1) and a second portion (P2).

19. The composition of any of claim 1 comprising:
100 pt. wt of component (A),
0.1 to about 10 pt. wt of at least one crosslinker (B),
0.01 to about 7 pt. wt. of the catalyst (C),
0.1 to about 5 pt. wt. of an amino-containing adhesion promoter (D),
0 to about 300 pt. wt. of filler (E),
0 to about 7 pt. wt of acidic component (F),
0.01 to about 15 pt. wt. of component (G),
whereby this composition can be stored in the absence of humidity and is curable in the presence of humidity upon exposure to ambient air.

20. A method of providing a cured material comprising exposing the composition of any of claim 1 to ambient air.

21. A method of providing a cured material comprising combining the first portion and the second portion of claim 18 and curing the mixture.

22. A cured polymer formed from the composition or method of any of claim 1.

23. The cured polymer of claim 22 in the form of an elastomeric seal, duromeric seal, an adhesive, a coating, an encapsulant, a shaped article, a mold, or an impression material.
